(19) United States
(12) Patent Application Publication
(10) Pub. No.: US 2023/0215469 A1
(43) Pub. Date: Jul. 6, 2023

(54) SYSTEM AND METHOD FOR ENHANCING MULTIMEDIA CONTENT WITH VISUAL EFFECTS AUTOMATICALLY BASED ON AUDIO CHARACTERISTICS

(71) Applicants: LAKSHMINATH REDDY DONDETI, San Jose, CA (US); VIDYA NARAYANAN, San Jose, CA (US)

(72) Inventors: LAKSHMINATH REDDY DONDETI, San Jose, CA (US); VIDYA NARAYANAN, San Jose, CA (US)

(21) Appl. No.: 18/092,460

(22) Filed: Jan. 3, 2023

Related U.S. Application Data
(60) Provisional application No. 63/296,500, filed on Jan. 5, 2022.

(51) Int. Cl. G11B 27/031; G06F 3/04845; G06F 3/0482; G11B 27/10; H04N 5/91; G10L 25/60; G10H 1/00

(52) U.S. Cl. CPC G11B 27/031; G06F 3/04845; G06F 3/0482; G11B 27/10; H04N 5/91; G10L 25/60; G10H 1/0008; H04N 23/632

(57) ABSTRACT

Exemplary embodiments of the present disclosure are directed towards system for enhancing multimedia content with visual effects based on audio characteristics, comprising computing device comprises multimedia content enhancing module enables end-user to record multimedia content using camera; enables to select audio track and combine with multimedia content recorded; sends audio track and multimedia content recorded to cloud server; cloud server comprising multimedia analyzing and visual effects retrieving module to receive and analyze beat characteristics of audio track and multimedia content recorded; categorize visual effects and filters and deliver to the computing device; multimedia content enhancing module displays categorized visual effects and filters on computing device and enables end-user to select and apply categorized visual effects and filters on multimedia content to create enhanced multimedia content; enables the end-user to share and post enhanced multimedia content on computing device.

### CROSS-REFERENCE TO RELATED APPLICATIONS

This patent application claims priority benefit of U.S. Provisional Patent Application No: 63/296,500, entitled “METHOD AND APPARATUS FOR ENHANCING VIDEOS WITH VISUAL EFFECTS AUTOMATICALLY BASED ON AUDIO CHARACTERISTICS”, filed on 5 Jan. 2022. The entire contents of the patent application is hereby incorporated by reference herein in its entirety.

### COPYRIGHT AND TRADEMARK NOTICE

This application includes material which is subject or may be subject to copyright and/or trademark protection. The copyright and trademark owner(s) has no objection to the facsimile reproduction by any of the patent disclosure, as it appears in the Patent and Trademark Office files or records, but otherwise reserves all copyright and trademark rights whatsoever.

### TECHNICAL FIELD

The present invention relates to automatically enhancing a user's recorded video by applying a series of visual effects and simulated camera movements to improve the visual appeal of the video. Secondly, it applies to a user touching an icon on a software application to invoke such automatic enhancements. Thirdly, it applies to detecting similar and distinct characteristics in the audio and using the right types of effects to use for maximum appeal. Lastly, this invention relates to synchronizing such effects to an audio or video track to create better experiences.

### BACKGROUND

Some existing cameras have auto enhancements that can fix the lighting, sharpness, brightness, and smoothness in photos and videos. None of these change the camera angle, zoom, color filters, backgrounds, or other characteristics in videos. Some creation tools offer individual filters and effects that a creator may choose during creation. None of these provide the ability to automatically combine filters and effects that come together contextually based on an audio track or video components.

In the light of the aforementioned discussion, there exists a need for a certain system to enhance videos with visual effects automatically based on audio characteristics on the computing device with novel methodologies that would overcome the above-mentioned challenges.

### SUMMARY

The following invention presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

An objective of the present disclosure is directed towards a system and computer implemented method for enhancing videos with visual effects automatically based on audio characteristics.

Another objective of the present disclosure is directed towards a system that enables an end-user to select an audio track to create a video.

Another objective of the present disclosure is directed towards a system that detects the types of beats in the audio track and relevant points based on the energy level changes to which different types of visual effects can be applied.

Another objective of the present disclosure is directed towards a system that enables the end-user to select the visual effects and add to the multimedia content after recording the multimedia content in post-processing.

Another objective of the present disclosure is directed towards a system that creates the visual effects based on the audio track and combines them on the camera as the creator records the multimedia content.

Another objective of the present disclosure is directed towards a system that allows the end-user to visualize the enhanced multimedia content as it is being recorded.

Another objective of the present disclosure is directed towards a system that categorizes the visual effects into multiple types that may be appropriate for different energy levels in the audio and different types of beats in the audio.

Another objective of the present disclosure is directed towards a system that enables the end-user to select the appropriate category of visual effects based on the characteristics of the audio track used to create the multimedia content.

Another objective of the present disclosure is directed towards a system that groups the visual effects in a way that a given group of visual effects are complementary and when applied together, they result in a highly appealing video.

Another objective of the present disclosure is directed towards a system that analyzes the lyrics of the selected audio track and enables the end-user to use the visual effects related to the semantics in the right places of the multimedia content. For example, foreground rain may be simulated when the lyrics refer to rain. Or a moon may be shown in the background when the lyrics refer to night-time or moonlight.

Another objective of the present disclosure is directed towards a system that applies visual effects in pairs to create symmetric outputs. For example, a transition animation to the right may then result in a transition animation to the left at a later point in the video.

Another objective of the present disclosure is directed towards a system that programmes the visual effects to follow the principles of physics such that they appear more realistic in the final video(For example, enhanced multimedia content).

Another objective of the present disclosure is directed towards a system that follows a pattern of visual effects similar to a reference video—for example, the pattern of visual effects may help to recreate a portion of an official music video.

Another objective of the present disclosure is directed towards a system that includes the visual effects that are language-independent and/or depends on the specific language of the audio track.

Another objective of the present disclosure is directed towards a system that performs sound analysis to keep track of audio fingerprints within the audio track to have uniformity in visual effects for similar sounds.

Another objective of the present disclosure is directed towards a system that performs sound analysis to identify different types of audio instruments from the audio track and use specific effects that are complementary to such instruments.

Another objective of the present disclosure is directed towards a system that enables the multimedia content enhancements to offer multiple versions of enhanced multimedia content for the end-user to select from.

Another objective of the present disclosure is directed towards a system that tracks the end-user's version of the multimedia content enhancements and adapts to the visual effects that the end-user is likely to select.

According to an exemplary aspect of the present disclosure, a system includes a computing device configured to establish communication with a cloud server over a network.

According to another exemplary aspect of the present disclosure, the computing device includes a multimedia content enhancing module is configured to enable an end-user to perform at least one of: record multimedia content using a camera; select the multimedia content stored in a memory of the computing device.

According to another exemplary aspect of the present disclosure, the multimedia content enhancing module is configured to enable the end-user to select an audio track and combine with at least one of: multimedia content recorded using the camera; and multimedia content selected from the memory of the computing device.

According to another exemplary aspect of the present disclosure, the multimedia content enhancing module is configured to send the audio track and at least one of: the multimedia content recorded using the camera; and the multimedia content selected from the memory of the computing device to the cloud server.

According to another exemplary aspect of the present disclosure, the cloud server includes a multimedia analyzing and visual effects retrieving module configured to receive and analyze beats characteristics of the audio track and at least one of: the multimedia content recorded using the camera; the multimedia content selected from the memory of the computing device.

According to another exemplary aspect of the present disclosure, the multimedia analyzing and visual effects retrieving module is configured to retrieve and categorize a series of visual effects and filters into multiple types based on the different beat characteristics in the audio track, and one or more video components of at least one of: the multimedia content recorded using the camera; the multimedia content selected from the memory of the computing device.

According to another exemplary aspect of the present disclosure, the multimedia analyzing and visual effects retrieving module on the cloud server is configured to deliver the series of categorized visual effects and filters to the multimedia content enhancing module on the computing device over the network.

According to another exemplary aspect of the present disclosure, the multimedia content enhancing module is configured to display the series of categorized visual effects and filters on the computing device and enable the end-user to select and apply the categorized visual effects and filters to at least one of: the multimedia content recorded using the camera; the multimedia content selected from the memory of the computing device; to create an enhanced multimedia content.

According to another exemplary aspect of the present disclosure, the multimedia content enhancing module is configured to enable the end-user to share and post the enhanced multimedia content on the computing device.

### BRIEF DESCRIPTION OF THE DRAWINGS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

FIG. 1 is a block diagram depicting a schematic representation of a system for enhancing multimedia content automatically with visual effects based on audio characteristics on a computing device, in accordance with one or more exemplary embodiments.

FIG. 2 is a block diagram depicting an embodiment of the multimedia content enhancing module 114 on the computing device 102 shown in FIG. 1, in accordance with one or more exemplary embodiments.

FIG. 3 is a block diagram depicting an embodiment of the multimedia content analyzing and visual effects retrieving module 114 on the computing device 102 shown in FIG. 1, in accordance with one or more exemplary embodiments.

FIG. 4 is a block diagram depicting the system for enhancing multimedia automatically with visual effects based on audio characteristics on the computing device, in accordance with one or more exemplary embodiments.

FIG. 5 are example screens depicting the multimedia enhancement module, in accordance with one or more exemplary embodiments.

FIG. 6 is a flow diagram depicting a method for enhancing multimedia content automatically with visual effects based on audio characteristics on the computing device, in accordance with one or more exemplary embodiments.

FIG. 7 is a block diagram illustrating the details of a digital processing system in which various aspects of the present disclosure are operative by execution of appropriate software instructions.

### DETAILED DESCRIPTION OF EXAMPLE EMBODIMENTS

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and so forth, herein do not denote any order, quantity, or importance, but rather are used to distinguish one element from another.

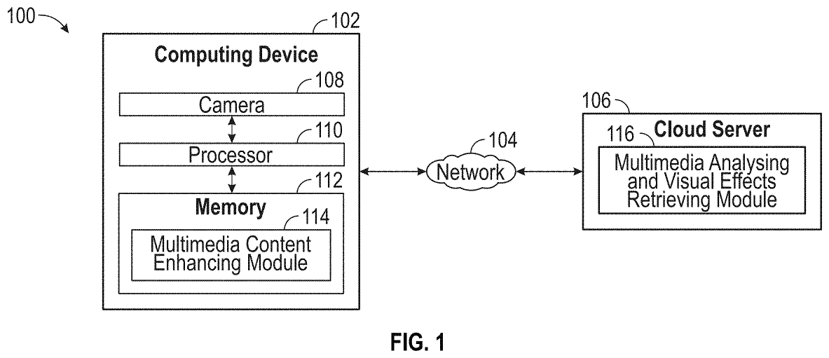

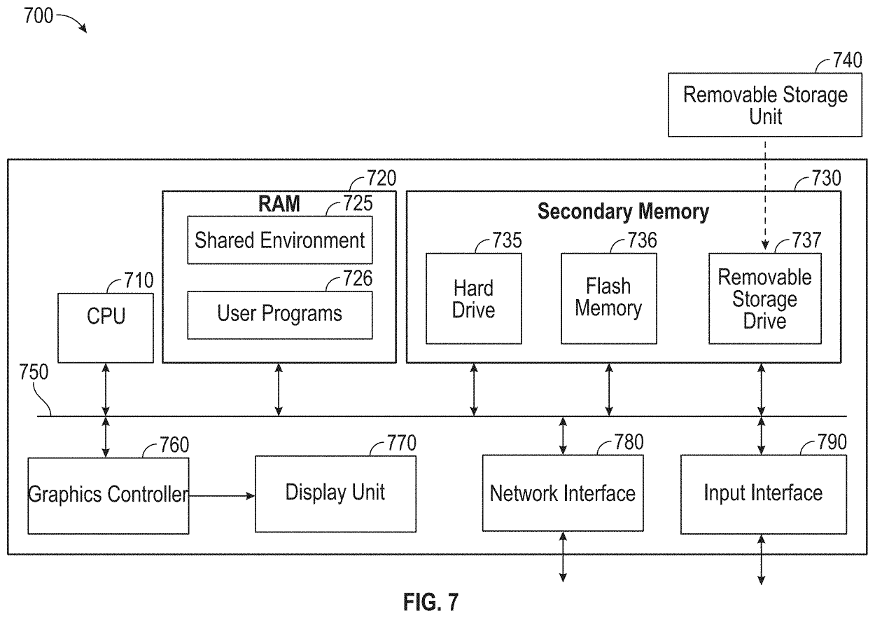

Referring to FIG. 1 is a block diagram 100 depicting a schematic representation of a system for enhancing multimedia content automatically with visual effects based on audio characteristics on a computing device, in accordance with one or more exemplary embodiments. The system 100 includes a computing device 102, a network 104, and a cloud server 106. The computing device 102 includes a camera 108, a processor 110, a memory 112, and a multimedia content enhancing module 114. The processor 110 may be a central processing unit and/or a graphics processing unit (As shown in FIG. 7). The cloud server 106 includes a multimedia analyzing and visual effects retrieving module 116. The multimedia content may include, but not limited to, video, audio clips, images, still photographs, or a collection of frames of images to create video or similar visual media, a portion of an image, an entire movie, a movie chapter, a movie scene, a movie shot, or a movie frame, or a plurality of images and/or videos, audio recordings or audio recording segments, and the like.

The computing device 102 may be connected to the one or more computing devices via the network 104. The computing device 102 may include, but is not limited to, a personal digital assistant, smartphones, personal computers, a mobile station, computing tablets, a handheld device, an internet enabled calling device, an internet enabled calling software, a telephone, a mobile phone, a digital processing system, and so forth. The network 104 may include, but not limited to, an Internet of things (IoT network devices), an Ethernet, a wireless local area network (WLAN), or a wide area network (WAN), a Bluetooth low energy network, a ZigBee network, a WIFI communication network e.g., the wireless high speed internet, or a combination of networks, a cellular service such as a 4G (e.g., LTE, mobile WiMAX) or 5G cellular data service, a RFID module, a NFC module, wired cables, such as the world-wide-web based Internet, or other types of networks may include Transport Control Protocol/Internet Protocol (TCP/IP) or device addresses (e.g. network-based MAC addresses, or those provided in a proprietary networking protocol, such as Modbus TCP, or by using appropriate data feeds to obtain data from various web services, including retrieving XML data from an HTTP address, then traversing the XML for a particular node) and so forth without limiting the scope of the present disclosure. The network 104 may be configured to provide access to different types of users.

The multimedia content enhancing module 114 on the computing device 102 is accessed as a mobile application, web application, software that offers the functionality of accessing mobile applications, and viewing/processing of interactive pages, for example, are implemented in the computing device 102, as will be apparent to one skilled in the relevant arts by reading the disclosure provided herein. For example, the multimedia content enhancing module 114 may be any suitable application downloaded from GOOGLE PLAY® (for Google Android devices), Apple Inc.'s APP STORE® (for Apple devices), or any other suitable database, server, webpage or uniform resource locator (URL). The multimedia content enhancing module 114 which may be a desktop application which runs on Mac OS, Microsoft Windows, Linux or any other operating system, and may be downloaded from a webpage or a CD/USB stick etc. In some embodiments, the multimedia content enhancing module 114 may be software, firmware, or hardware that is integrated into the computing device 102.

Although the computing device 102 is shown in FIG. 1, an embodiment of the system 100 may support any number of computing devices. The computing device 102 may be operated by the end-user. The end-user may include, but not limited to, an individual, a client, an operator, a user, a creator, and so forth. The computing device 102 supported by the system 100 is realized as a computer-implemented or computer-based device having the hardware or firmware, software, and/or processing logic needed to carry out the computer-implemented methodologies described in more detail herein.

In accordance with one or more exemplary embodiments of the present disclosure, the computing device 102 includes the camera 108 may be configured to enable the end-user to record the multimedia content through the processor 104. The multimedia content enhancing module 114 may automatically enhance the recorded multimedia content on the computing device 102 by applying a series of visual effects and simulated camera movements to improve the visual appeal of the multimedia content. The visual effects also known as VFX effects, create or manipulate images outside the context of a live-action shot in filmmaking and video production. The integration of live-action footage and camera graphic elements to create realistic imagery is called VFX effects.

Secondly, the multimedia content enhancing module 114 may be configured to enable the end-user to apply the visual effects and filters to the recorded multimedia content upon touching an icon existing in the multimedia content enhancing module 114 to invoke such automatic enhancements. Thirdly, the multimedia content enhancing module 114 may be configured to apply the visual effects and filters to similar and distinct audio characteristics detected in the audio track and use the right types of effects to use for maximum appeal. The audio/beat characteristics may include, but not limited to, lyrics, different types of beats, beat characteristics, one or more of energy levels, type of instruments, timing of beats, and the like. The multimedia content enhancing module 114 may be configured to synchronize such visual effects and filters to an audio or video track to create better experiences.

The visual effects and filters are added automatically as the end-user records the multimedia content using the camera 108. This allows the end-user to visualize the enhanced multimedia content as it is being recorded. The visual effects and filters are categorized into multiple types that may be appropriate for different audio characteristics in the audio and different types of beats in the audio. The multimedia content enhancing module 114 may be configured to enable the end-user to select the appropriate category of visual effects based on the beat characteristics of the audio track used to create the multimedia content.

In another embodiment of the invention, the visual effects and filters may be grouped in a way that a given group of effects are complementary and when applied together, they result in a highly appealing video. The multimedia content enhancing module 114 may be configured to suggest the visual effects and filters related to the semantics in the right places of the multimedia content based on the beats characteristics of the audio track selected by the end-user. The multimedia content enhancing module 114 may be configured to suggest the visual effects and filters related to the semantics in the right places of the multimedia content based on the lyrics of the audio track selected by the end-user. For example, foreground rain may be simulated when the lyrics refer to rain. Or a moon may be shown in the background when the lyrics refer to night-time or moonlight. The visual effects and filters may be applied in pairs to create symmetric outputs. For example, a transition animation to the right may then result in a transition animation to the left at a later point in the video. The visual effects and filters may be programmed to follow the principles of physics such that they appear more realistic in the final video. The visual effects and filters may also follow a pattern similar to a reference video - for example, they may help to recreate a portion of an official music video. The multimedia content enhancing module 114 may be configured to analyse the beats characteristics of the selected audio track and apply the visual effects and filters to the multimedia content automatically on the computing device 102 as the end-user records the multimedia content. The applied visual effects and filters are related to the semantics in the right places of the multimedia content based on the anlayzed beats characteristics of the audio track selected by the end-user.

The visual effects and filters may be language-independent or may depend on the specific language of the audio track. The sound analysis may keep track of audio fingerprints within the audio track to have uniformity in the visual effects for similar sounds. The sound analysis may also identify different types of audio instruments from the audio track and use specific effects that are complementary to such instruments. The multimedia content enhancing module 114 may enable the multimedia content enhancements to offer multiple versions of enhanced multimedia content for the end-user to choose from. The multimedia content enhancing module 114 may be configured to keep track of the end-users chosen version of the multimedia content enhancements and adapt to the visual effects and filters that the end-user is likely to choose. The multimedia content enhancing module 114 may be configured to perform processing of the multimedia content by applying the series of visual effects and filters on the computing device without the cloud server 106.

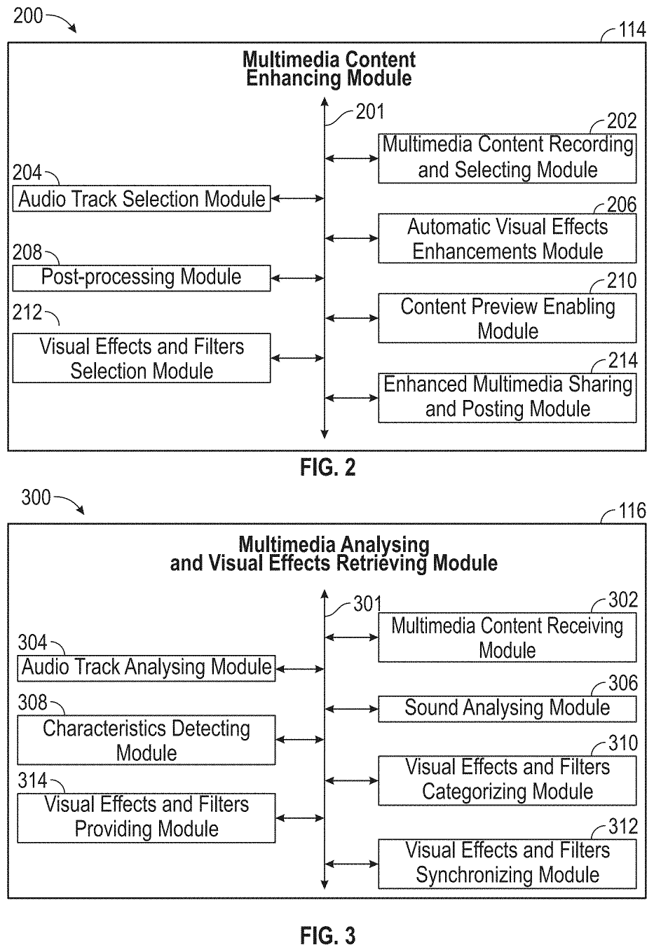

Referring to FIG. 2 is a block diagram 200 depicting an embodiment of the multimedia content enhancing module 114 on the computing device 102 of shown in FIG. 1, in accordance with one or more exemplary embodiments. The diagram 200 includes a multimedia content recording and selection module 202, an audio track selection module 204, an automatic visual effects enhancements module 206, a post-processing module 208, a content preview enabling module 210, and visual effects and filters selection module 212, and an enhanced multimedia sharing and posting module 214.

The multimedia content recording and selection module 202 may be configured to enable the end-user to record the multimedia content on the computing device 102 using the camera 108. The multimedia content recording and selection module 202 may be configured to enable the end-user to select the multimedia content stored in the memory of the computing device, and the like. The audio track selection enabling module 204 may be configured to enable the end-user to select an audio track from the memory 112 of the computing device 102 to create a video. The multimedia enhancement module 206 may be configured to apply the visual effects and filters automatically related to the semantics in the right places based on the lyrics and/or beats characteristics of the selected audio track.

The visual effects and filters are categorized into multiple types that may be appropriate for different beat characteristics in the audio track. The visual effects and filters are also categorized into multiple types that may be appropriate for different energy levels in the audio track and different types of beats in the audio track. Based on the audio/beat characteristics of the audio track used to create the video, the appropriate category of visual effects and the filters can be selected. The visual effects and filters may be grouped in a way that a given group of visual effects are complementary and when applied together, they result in a highly appealing video. The beats characteristics of the audio track may be analysed and apply the visual effects and filters to the multimedia content that match the beats. The lyrics of the selected audio track may be analysed and the visual effects and filters related to the semantics may be used in the right places. For example, foreground rain may be simulated when the lyrics refer to rain. Or a moon may be shown in the background when the lyrics refer to night-time or moonlight.

The automatic visual effects enhancements module 206 may be configured to detect the types of beats in the audio track and relevant points based on the energy level changes to which different types of the visual effects and filters can be applied. The automatic visual effects enhancements module 206 may be configured to apply the visual effects and filters automatically on the camera 108 as the end-user records the video. The automatic visual effects enhancements module 206 may be configured to enable the end-user to visualize the enhanced video (enhanced multimedia content) as it is being recorded using the camera 108 on the computing device 102. The visual effects and filters may be applied in pairs to create symmetric outputs. For example, a transition animation to the right in the video may then result in a transition animation to the left at a later point in the video.

The visual effects and filters may be programmed in the memory 112 to follow the principles of physics such that they appear more realistic in the final video. The visual effects and filters may also follow a pattern similar to a reference video—for example, they may help recreate a portion of an official music video. The visual effects and filters may be language-independent or may depend on the specific language of the audio track. The sound analysis may keep track of audio fingerprints within the audio track to have uniformity in the visual effects for similar sounds. The sound analysis may also identify different types of audio instruments from the audio track and enable the end-user to use specific visual effects that are complementary to such instruments.

The post-processing module 208 may be configured to enable the end-user to apply the selected visual effects and filters to the recorded video and enables these video enhancements to offer multiple versions of enhanced videos for the end-user to choose from. The content preview enabling module 210 may be configured to enable the end-user to preview the automatically enhanced video when recorded using the camera 108. The visual effects and filters selection module 212 may be configured to enable the end-user to select the visual effects and filters to create the enhanced video. The visual effects and filters selection module 212 may keep track of the end-user's selected version of the enhancements and adapt to the visual effects that the end-user is likely to select. The enhanced multimedia sharing and posting module 214 may be configured to enable the end-user to share and post the enhanced multimedia content on the computing device 102.

Referring to FIG. 3 is a block diagram 300 depicting an embodiment of the multimedia content analyzing and visual effects retrieving module 114 on the computing device 102 of shown in FIG. 1, in accordance with one or more exemplary embodiments. The diagram 300 includes the multimedia analyzing and visual effects retrieving module 116. The multimedia analyzing and visual effects retrieving module 116 includes a multimedia content receiving module 302, an audio track analyzing module 304, a sound analyzing module 306, characteristics detecting module 308, visual effects and filters categorizing module 310, visual effects and filters synchronizing module 312, and visual effects and filters providing module 314.

The multimedia content receiving module 302 may be configured to receive the recorded multimedia and the selected audio track from the computing device 102 over the network 104. The audio track analyzing module 304 may be configured to analyze the beat characteristics of the selected audio track. The audio track analyzing module 304 may be configured to analyze the lyrics of the selected audio track. The sound analyzing module 306 may be configured to analyze the sound of the selected audio track. The sound analysing module 306 may be configured to perform sound analysis to keep track of audio fingerprints within the audio track to have uniformity in effects for similar sounds. The sound analyzing module 306 may be configured to perform sound analysis to identify different types of audio instruments from the audio track and use specific effects that are complementary to such instruments. The characteristics detecting module 308 may be configured to detect similar and distinct beat characteristics in the audio track and use the right visual effects and filters to use for maximum appeal. The audio and/or beat characteristics, may include, but not limited to, one or more of energy levels, type of instruments, timing of beats, different types of beats, and the like.

The visual effects and filters categorizing module 310 may be configured to retrieve and categorize the series of visual effects and filters into multiple types based on the different beat characteristics detected in the audio track, and the detected video components of the multimedia content recorded using the camera 108 and/or the multimedia content selected from the memory 112 of the computing device 102. The visual effects and filters synchronizing module 312 may be configured to synchronize the visual effects and filters to the audio or video track to create better experiences. The visual effects and filters providing module 314 may be configured to provide the visual effects and filters to the computing device based on the analyzed beat characteristics and/or the lyrics of the selected audio track.

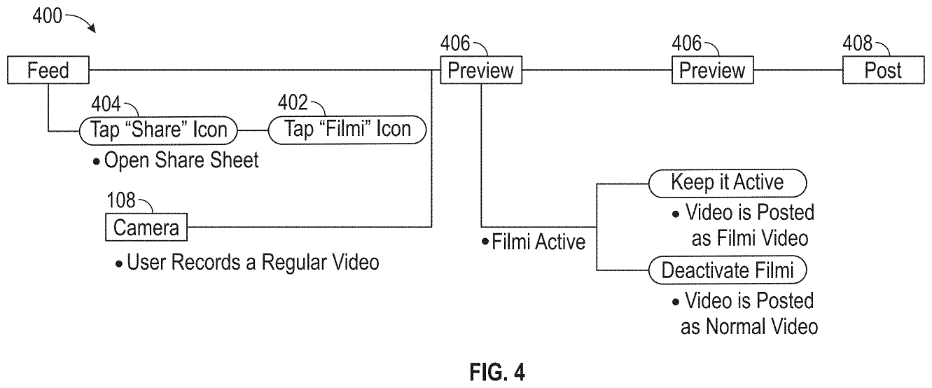

Referring to FIG. 4 is a block diagram 400 depicting the system for enhancing multimedia content automatically with visual effects based on audio characteristics on the computing device, in accordance with one or more exemplary embodiments. The diagram 400 includes the camera 108, a filmi icon 402, a share icon 404, a preview option 406, and a post option 408. The camera 108 may be configured to add the visual effects and filters automatically as the creator records the video. This allows the creator to visualize or preview the enhanced video as it is being recorded. The filmi icon 402 may be configured to automatically enhance the creator recorded video by applying the series of visual effects and simulated camera movements to improve the visual appeal of the video. The series of visual effects and filter may apply when the creator/end-user touches the filmi icon 402 on the multimedia content enhancing module 114 to invoke such automatic enhancements. The share icon 404 may be configured to enable the creator/end-user to share the enhanced multimedia content created on the computing device 102 to secondary computing devices. The secondary computing devices may be operated by friends, family, and the like. The preview option 406 may be configured to enable the creator/end-user to preview the enhanced multimedia content as it being recorded. The post option 408 may be configured to enable the end-user to post the enhanced multimedia content on the computing device 102.

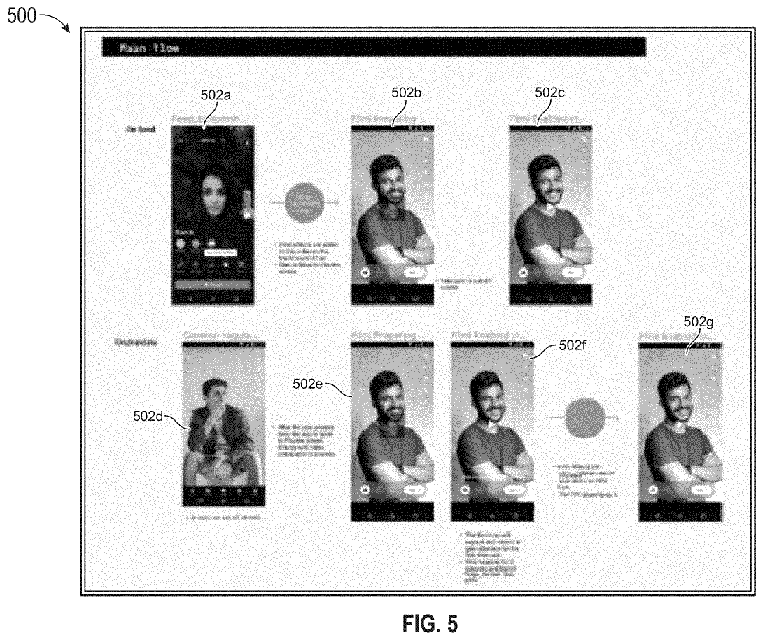

Referring to FIG. 5 are example screens 500 depicting the multimedia enhancement module, in accordance with one or more exemplary embodiments. The screens 500 includes multimedia screens 502a, 502b, 502c, 502d, 502e, 502f and 502g. The screens 502a, 502b, 502c, 502d, 502e, 502f and 502g depicts enhancing videos with the visual effects automatically based on audio characteristics. A creator picks an audio track to create a video, and the system detects the types of beats in the audio and relevant points based on an energy level change to which different types of visual effects and filters may be applied. After the creator records the video, add the chosen visual effects and filters to the video in post-processing. Visual effects are added to the video as the creator records the video using the camera, this allows the creator to visualize the enhanced video as it is being recorded. Categorize the visual effects into multiple types that may be appropriate for different energy levels in the audio and different types of beats characteristics in the audio. The visual effects follow a pattern similar to a reference video, the sound analysis keeps track of audio fingerprints within the audio track to have uniformity in effects for similar sounds. The sound analysis also identifies different types of audio instruments from the audio track.

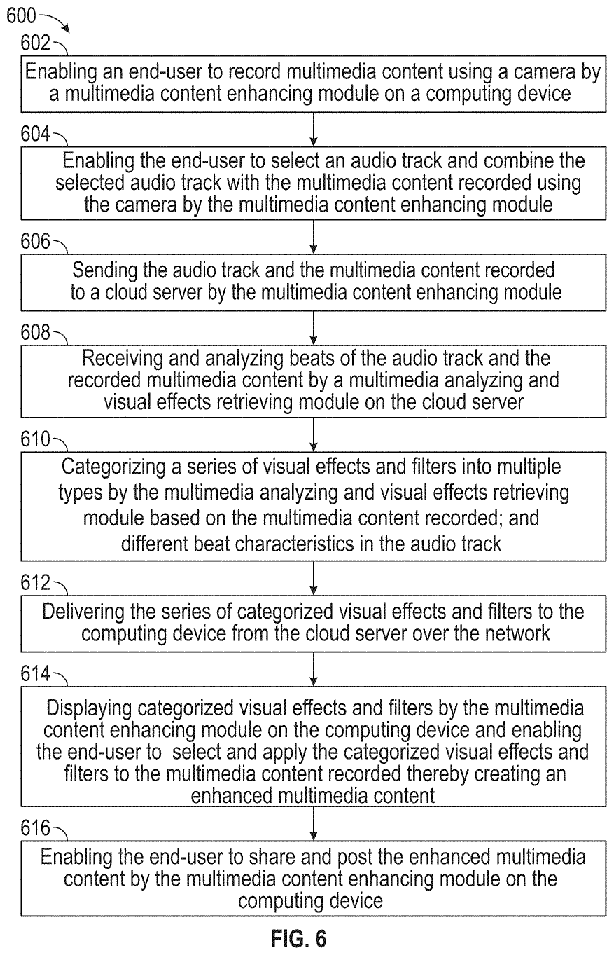

Referring to FIG. 6 is a flow diagram 600 depicting a method for enhancing multimedia content automatically with visual effects based on audio characteristics on the computing device, in accordance with one or more exemplary embodiments. The method 600 may be carried out in the context of the details of FIG. 1, FIG. 2, FIG. 3, FIG. 4, and FIG. 5. However, the method 600 may also be carried out in any desired environment. Further, the aforementioned definitions may equally apply to the description below.

The method commences at step 602, enabling the end-user to perform at least one of: recording multimedia content using the camera;; selecting the multimedia content stored in the memory by the multimedia content enhancing module on the computing device. Thereafter at step 604, enabling the end-user to select the audio track and combine the selected audio track with at least one of: the multimedia content recorded using the camera; the multimedia content selected from the memory of the computing device by the multimedia content enhancing module. Thereafter at step 606, sending the audio track and at least one of: the multimedia content recorded using the camera; the multimedia content selected from the memory to the cloud server by the multimedia content enhancing module. Thereafter at step 608, receiving and analyzing the beats of the audio track and at least one of: the multimedia content recorded; the multimedia content selected from the memory by the multimedia analyzing and visual effects retrieving module on the cloud server. Thereafter at step 610, categorizing the series of visual effects and filters into multiple types by the multimedia analyzing and visual effects retrieving module based on the analysed beats, one or more video components of at least one of: the multimedia content recorded; the multimedia content selected from the memory, different energy levels in the audio track and different types of beats in the audio track.

Thereafter at step 612, delivering the series of categorized visual effects and filters to the computing device from the cloud server over the network. Thereafter at step 614, displaying the categorized visual effects and filters on the multimedia content enhancing module and enabling the end-user to select and apply the categorized visual effects and filters to at least one of: the multimedia content recorded; the multimedia content selected from the memory; to create an enhanced multimedia content. Thereafter at step 616, enabling the end-user to share and post the enhanced multimedia content on the computing device by the multimedia content enhancing module.

Referring to FIG. 7 is a block diagram 700 illustrating the details of a digital processing system 700 in which various aspects of the present disclosure are operative by execution of appropriate software instructions. The Digital processing system 700 may correspond to the computing device 102 (or any other system in which the various features disclosed above can be implemented).

Digital processing system 700 may contain one or more processors such as a central processing unit (CPU) 710, random access memory (RAM) 720, secondary memory 730, graphics controller 760, display unit 770, network interface 780, and input interface 790. All the components except display unit 770 may communicate with each other over communication path 750, which may contain several buses as is well known in the relevant arts. The components of FIG. 7 are described below in further detail.

CPU 710 may execute instructions stored in RAM 720 to provide several features of the present disclosure. CPU 710 may contain multiple processing units, with each processing unit potentially being designed for a specific task. Alternatively, CPU 710 may contain only a single general-purpose processing unit.

RAM 720 may receive instructions from secondary memory 730 using communication path 750. RAM 720 is shown currently containing software instructions, such as those used in threads and stacks, constituting shared environment 725 and/or user programs 726. Shared environment 725 includes operating systems, device drivers, virtual machines, etc., which provide a (common) run time environment for execution of user programs 726.

Graphics controller 760 generates display signals (e.g., in RGB format) to display unit 770 based on data/instructions received from CPU 710. Display unit 770 contains a display screen to display the images defined by the display signals. Input interface 790 may correspond to a keyboard and a pointing device (e.g., touch-pad, mouse) and may be used to provide inputs. Network interface 780 provides connectivity to a network (e.g., using Internet Protocol), and may be used to communicate with other systems (such as those shown in FIG. 1) connected to the network 104.

Secondary memory 730 may contain hard drive 735, flash memory 736, and removable storage drive 737. Secondary memory 730 may store the data software instructions (e.g., for performing the actions noted above with respect to the Figures), which enables digital processing system 700 to provide several features in accordance with the present disclosure.

Some or all of the data and instructions may be provided on removable storage unit 740, and the data and instructions may be read and provided by removable storage drive 737 to CPU 710. Floppy drive, magnetic tape drive, CD-ROM drive, DVD Drive, Flash memory, removable memory chip (PCMCIA Card, EEPROM) are examples of such removable storage drive 737.

Removable storage unit 740 may be implemented using medium and storage format compatible with removable storage drive 737 such that removable storage drive 737 can read the data and instructions. Thus, removable storage unit 740 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 740 or hard disk installed in hard drive 735. These computer program products are means for providing software to digital processing system 700. CPU 710 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 730. Volatile media includes dynamic memory, such as RAM 720. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus (communication path) 750. Transmission media can also take the form of acoustic or light waves, such as those generated during radio-wave and infra-red data communications.

In the preferred embodiment of this invention, the system for enhancing multimedia content with visual effects based on audio characteristics, includes: the computing device 102 configured to establish communication with the cloud server 106 over the network 104, the computing device 102 includes the multimedia content enhancing module 114 may be configured to enable an end-user to perform at least one of: record multimedia content using the camera; select the multimedia content stored in the memory of the computing device.

In another embodiment of this invention, the multimedia content enhancing module 114 may be configured to enable the end-user to select an audio track and combine with at least one of: multimedia content recorded using the camera; selected feed; and multimedia content selected from the memory of the computing device, the multimedia content enhancing module 114 may be configured to send the audio track and at least one of: the multimedia content recorded using the camera; and the multimedia content selected from the memory 112 of the computing device 102 to the cloud server 106.

In another embodiment of this invention, the cloud server 106 includes the multimedia analyzing and visual effects retrieving module 116 may be configured to receive and analyze beats characteristics of the audio track and at least one of: the multimedia content recorded using the camera 108; the multimedia content selected from the memory 112 of the computing device 102.

In another embodiment of this invention, the multimedia analyzing and visual effects retrieving module 116 may be configured to retrieve and categorize a series of visual effects and filters into multiple types based on one or more video components of at least one of: the multimedia content recorded using the camera 108; the multimedia content selected from the memory 112 of the computing device 102, different types of beat characteristics in the audio track.

In another embodiment of this invention, the multimedia analyzing and visual effects retrieving module 116 on the cloud server 106 may be configured to deliver the series of categorized visual effects and filters to the multimedia content enhancing module 114 on the computing device 102 over the network 104.

In another embodiment of this invention, the multimedia content enhancing module 114 may be configured to display the series of categorized visual effects and filters on the computing device 102 and enable the end-user to select and apply the categorized visual effects and filters to at least one of: the multimedia content recorded using the camera; the multimedia content selected from the memory 112 of the computing device 102; to create an enhanced multimedia content.

In another embodiment of this invention, the multimedia analyzing and visual effects retrieving module 116 may be configured to analyze lyrics of the audio track and at least one of: the multimedia content recorded using the camera; the multimedia content selected from the memory of the computing device. The beat characteristics comprises one or more energy levels, type of instruments, and timing of beats, overall intensity and kinetic energy within the audio track, sustained tones.

In another embodiment of this invention, the multimedia content enhancing module 114 may be configured to enable the end-user to share and post the enhanced multimedia content on the computing device 102. The multimedia content enhancing module 114 may be configured to perform processing of the multimedia content by applying the series of visual effects and filters on the computing device without the cloud server 106. The multimedia content enhancing module 114 may be configured to enable the end-user to shuffle through multiple combinations of series of visual effects and filters to select one visual effect and filter from the series of visual effects and filters.

In another embodiment of this invention, the multimedia content enhancing module 114 may be configured to enhance the multimedia content automatically by applying the series of visual effects and filters and simulated camera movements to improve the visual appeal of the multimedia content based on the audio track. The multimedia content enhancing module 114 may be configured to enable the end-user to apply the series of visual effects and filters to the multimedia content manually upon touching an icon on the multimedia content enhancing module 114 to invoke automatic enhancements.

In another embodiment of this invention, the multimedia content enhancing module 114 includes the multimedia content recording and selection module 202 may be configured to enable the end-user to record the multimedia content on the computing device 102 using the camera 108 and to perform at least one of: selecting the multimedia content stored in the memory 112 of the computing device 102; the audio track selection enabling module 204 may be configured to enable the end-user to select the audio track to create the enhanced multimedia content; the automatic visual effects enhancements module 206 may be configured to apply the series of visual effects and filters automatically related to the semantics in the right places based on the beats/lyrics of the selected audio track. The automatic visual effects enhancements module 206 may be configured to enable the end-user to visualize the enhanced multimedia content on the computing device 102 as the multimedia content is being recorded using the camera 108. The automatic visual effects enhancements module 206 may be configured to detect the types of beats in the audio track and relevant points based on the energy level changes and beat characteristics to which different types of visual effects can be applied. The automatic visual effects enhancements module 206 may be configured to enable the end-user to apply the series of visual effects and filters on the computing device 102 as the end-user records the multimedia content using the camera 108.

In another embodiment of this invention, the multimedia content enhancing module 114 includes the post-processing module 208 may be configured to enable the end-user to apply the series of visual effects and filters to the multimedia content and to select the enhanced multimedia content from multiple versions of the enhanced multimedia contents; the content preview enabling module 210 may be configured to enable the end-user to preview the enhanced multimedia content automatically when recorded; the visual effects and filters selection module 212 may be configured to enable the end-user to select a desired visual effects and filters to create the enhanced multimedia content; the visual effects and filters selection module 212 may be configured to keep track of the end-user's selected version of the multimedia enhancements and adapt to the visual effects that the end-user is likely to select.

In another embodiment of this invention, the multimedia analyzing and visual effects retrieving module 116 includes the multimedia content receiving module 302 may be configured to receive at least one of: the multimedia content recorded using the camera 108; the multimedia content selected from the memory of the computing device 102; and the selected audio track from the computing device 102 over the network 106; the audio track analyzing module 304 may be configured to analyze the beats and/or the lyrics of the selected audio track and perform sound analysis to identify different types of audio instruments from the audio track and use specific effects that are complementary to such instruments; the sound analyzing module 306 may be configured to analyze sound of the selected audio track. The sound analyzing module 306 may be configured to perform sound analysis to keep track of audio fingerprints within the audio track to have uniformity in effects for similar sounds.

In another embodiment of this invention, the characteristics detecting module 308 may be configured to detect similar and distinct beat characteristics in the audio track, thereby enabling the user to use the right types of visual effects and filters to create the enhanced multimedia content; the visual effects and filters synchronizing module 312 may be configured to synchronize the visual effects and filters to the multimedia content to create better experiences.

In another embodiment of this invention, a method for enhancing multimedia content with visual effects based on audio characteristics, comprising: enabling an end-user to perform at least one of: recording multimedia content using a camera; selecting the multimedia content stored in a memory by a multimedia content enhancing module on the computing device; enabling the end-user to select an audio track and combine the selected audio track with at least one of: the multimedia content recorded using the camera; the multimedia content selected from the memory of the computing device by the multimedia content enhancing module; sending the audio track and at least one of: the multimedia content recorded using the camera; the multimedia content selected from the memory to the cloud server by the multimedia content enhancing module; receiving and analyzing beats and/or lyrics of the audio track and at least one of: the multimedia content recorded; the multimedia content selected from the memory by a multimedia analyzing and visual effects retrieving module on the cloud server; categorizing a series of visual effects and filters into multiple types by the multimedia analyzing and visual effects retrieving module based on one or more video components of at least one of: the multimedia content recorded; the multimedia content selected from the memory, different beat characteristics in the audio track and different types of beats in the audio track; delivering the series of categorized visual effects and filters to the computing device from the cloud server over the network; displaying categorized visual effects and filters on the multimedia content enhancing module and enabling the end-user to select and apply the categorized visual effects and filters to at least one of: the multimedia content recorded; the multimedia content selected from the memory; to create an enhanced multimedia content; and enabling the end-user to share and post the enhanced multimedia content on the computing device by the multimedia content enhancing module.

In another embodiment of this invention, a computer program product comprising a non-transitory computer-readable medium having a computer-readable program code embodied therein to be executed by one or more processors, said program code including instructions to: enable an end-user to perform at least one of: record multimedia content using a camera; select the multimedia content stored in a memory by a multimedia content enhancing module on the computing device; enable the end-user to select an audio track and combine the selected audio track with at least one of: the multimedia content recorded using the camera; the multimedia content selected from the memory of the computing device by the multimedia content enhancing module; send the audio track and at least one of: the multimedia content recorded using the camera; the multimedia content selected from the memory to the cloud server by the multimedia content enhancing module; receive and analyze beats characteristics of the audio track and at least one of: the multimedia content recorded; the multimedia content selected from the memory by a multimedia analyzing and visual effects retrieving module on the cloud server; retrieve and categorize a series of visual effects and filters into multiple types by the multimedia analyzing and visual effects retrieving module based on different beat characteristics in the audio track, and one or more video components of at least one of: the multimedia content recorded; the multimedia content selected from the memory; deliver the series of categorized visual effects and filters to the computing device from the cloud server over the network; display categorized visual effects and filters on the multimedia content enhancing module and enable the end-user to select and apply the categorized visual effects and filters to at least one of: the multimedia content recorded; the multimedia content selected from the memory; to create an enhanced multimedia content; and enable the end-user to share and post the enhanced multimedia content on the computing device by the multimedia content enhancing module.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

Although the present disclosure has been described in terms of certain preferred embodiments and illustrations thereof, other embodiments and modifications to preferred embodiments may be possible that are within the principles and spirit of the invention. The above descriptions and figures are therefore to be regarded as illustrative and not restrictive.

Thus the scope of the present disclosure is defined by the appended claims and includes both combinations and sub-combinations of the various features described hereinabove as well as variations and modifications thereof, which would occur to persons skilled in the art upon reading the foregoing description.

What is claimed is:

1. A system for enhancing multimedia content with visual effects based on audio characteristics, comprising:
a computing device configured to establish communication with a cloud server over a network, whereby the computing device comprises a multimedia content enhancing module configured to enable an end-user to perform at least one of: record multimedia content using a camera; select the multimedia content stored in a memory of the computing device;
the multimedia content enhancing module configured to enable the end-user to select an audio track and combine with at least one of: multimedia content recorded using the camera; and multimedia content selected from the memory of the computing device, whereby the multimedia content enhancing module configured to send the audio track and at least one of: the multimedia content recorded using the camera; and the multimedia content selected from the memory of the computing device to the cloud server;
the cloud server comprising a multimedia analyzing and visual effects retrieving module configured to receive and analyze one or more beats characteristics of the audio track and at least one of: the multimedia content recorded using the camera; the multimedia content selected from the memory of the computing device, whereby the multimedia analyzing and visual effects retrieving module configured to retrieve and categorize the series of visual effects and filters into multiple types based on the one or more beat characteristics in the audio track, and one or more video components of at least one of: the multimedia content recorded using the camera; the multimedia content selected from the memory of the computing device;
the multimedia analyzing and visual effects retrieving module on the cloud server configured to deliver the series of categorized visual effects and filters to the multimedia content enhancing module on the computing device over the network, whereby the multimedia content enhancing module configured to display the series of categorized visual effects and filters on the computing device and enable the end-user to select and apply the categorized visual effects and filters to at least one of: the multimedia content recorded using the camera; the multimedia content selected from the memory of the computing device; to create an enhanced multimedia content; and
the multimedia content enhancing module configured to enable the end-user to share and post the enhanced multimedia content on the computing device.

2. The system of claim 1, wherein the multimedia analyzing and visual effects retrieving module configured to analyze lyrics of the audio track and at least one of: the multimedia content recorded using the camera; the multimedia content selected from the memory of the computing device.

3. The system of claim 1, wherein the beat characteristics of the audio track comprises at least one: one or more energy levels; type of instruments; timing of beats; overall intensity and kinetic energy within the audio track; and sustained tones.

4. The system of claim 1, wherein the multimedia content enhancing module is configured to enhance the multimedia content automatically by applying the series of visual effects and filters and simulated camera movements to improve the visual appeal of the multimedia content based on the audio track.

5. The system of claim 1, wherein the multimedia content enhancing module is configured to enable the end-user to apply the series of visual effects and filters to the multimedia content manually upon touching an icon on the multimedia content enhancing module to invoke automatic enhancements.

6. The system of claim 1, wherein the multimedia content enhancing module is configured to perform processing of the multimedia content by applying series of visual effects and filters on the computing device without the cloud server.

7. The system of claim 1, wherein the multimedia content enhancing module is configured to enable the end-user to shuffle through multiple combinations of series of visual effects and filters to select one visual effect and filter from the series of visual effects and filters.

8. The system of claim 1, wherein the multimedia content enhancing module comprising a multimedia content recording and selection module is configured to enable the end-user to record the multimedia content on the computing device using the camera and to perform at least one of: selecting the feed; selecting the multimedia content stored in the memory of the computing device.

9. The system of claim 1, wherein the multimedia content enhancing module comprising an audio track selection enabling module is configured to enable the end-user to select the audio track to create the enhanced multimedia content.

10. The system of claim 1, wherein the multimedia content enhancing module comprising an automatic visual effects enhancements module is configured to apply the series of visual effects and filters automatically related to the semantics in the right places based on the lyrics of the selected audio track.

11. The system of claim 10, wherein the automatic visual effects enhancements module is configured to enable the end-user to visualize the enhanced multimedia content on the computing device as the multimedia content is being recorded using the camera.

12. The system of claim 10, wherein the automatic visual effects enhancements module is configured to detect the types of beats in the audio track and relevant points based on the energy level changes to which different types of visual effects can be applied.

13. The system of claim 10, wherein the automatic visual effects enhancements module is configured to enable the end-user to apply the series of visual effects and filters on the computing device as the end-user records the multimedia content using the camera.

14. The system of claim 1, wherein the multimedia content enhancing module comprising a post-processing module is configured to enable the end-user to apply the series of visual effects and filters to the multimedia content and enables to select the enhanced multimedia content from multiple versions of the enhanced multimedia content.

15. The system of claim 1, wherein the multimedia content enhancing module comprising a content preview enabling module is configured to enable the end-user to preview the automatically enhanced multimedia content when recorded using the camera.

16. The system of claim 1, wherein the multimedia content enhancing module comprising a visual effects and filters selection module is configured to enable the end-user to select a desired visual effects and filters to create the enhanced multimedia content.

17. The system of claim 16, wherein the visual effects and filters selection module is configured to keep track of the end-user's selected version of the multimedia enhancements and adapt to the visual effects that the end-user is likely to select.

18. The system of claim 1, wherein the multimedia analyzing and visual effects retrieving module comprising a multimedia receiving module is configured to receive at least one of: the multimedia content recorded using the camera; the multimedia content selected from the memory of the computing device; and the selected audio track from the computing device over the network.

19. The system of claim 1, wherein the multimedia analyzing and visual effects retrieving module comprising an audio track analyzing module is configured to analyze the lyrics of the selected audio track and perform sound analysis to identify different types of audio instruments from the audio track and use specific effects that are complementary to such instruments.

20. The system of claim 1, wherein the multimedia analyzing and visual effects retrieving module comprising a sound analyzing module is configured to analyze sound of the selected audio track.

21. The system of claim 20, wherein the sound analyzing module is configured to perform sound analysis to keep track of audio fingerprints within the audio track to have uniformity in effects for similar sounds.

22. The system of claim 1, wherein the multimedia analyzing and visual effects retrieving module comprising a characteristics detecting module is configured to detect similar and distinct beat characteristics in the audio track thereby enabling the user to use the right types of visual effects to create the enhanced multimedia content.

23. The system of claim 1, wherein the multimedia analyzing and visual effects retrieving module comprising a visual effects and filters synchronizing module is configured to synchronize the visual effects and filters to the multimedia content to create better experiences.

24. A method for enhancing multimedia content with visual effects based on audio characteristics, comprising:
enabling an end-user to perform at least one of: recording multimedia content using a camera; selecting the multimedia content stored in a memory by a multimedia content enhancing module on the computing device;
enabling the end-user to select an audio track and combine the selected audio track with at least one of: the multimedia content recorded using the camera; the multimedia content selected from the memory of the computing device by the multimedia content enhancing module;
sending the audio track and at least one of: the multimedia content recorded using the camera; the multimedia content selected from the memory to the cloud server by the multimedia content enhancing module;
receiving and analyzing beats characteristics of the audio track and at least one of: the multimedia content recorded; the multimedia content selected from the memory by a multimedia analyzing and visual effects retrieving module on the cloud server;
retrieving and categorizing a series of visual effects and filters into multiple types by the multimedia analyzing and visual effects retrieving module based on different beat characteristics in the audio track, and one or more video components of at least one of: the multimedia content recorded; the multimedia content selected from the memory;
delivering the series of categorized visual effects and filters to the computing device from the cloud server over the network;
displaying categorized visual effects and filters on the multimedia content enhancing module and enabling the end-user to select and apply the categorized visual effects and filters to at least one of: the multimedia content recorded; the multimedia content selected from the memory; to create an enhanced multimedia content; and
enabling the end-user to share and post the enhanced multimedia content on the computing device by the multimedia content enhancing module.

25. A computer program product comprising a non-transitory computer-readable medium having a computer-readable program code embodied therein to be executed by one or more processors, said program code including instructions to:
enable an end-user to perform at least one of: record multimedia content using a camera; select the multimedia content stored in a memory by a multimedia content enhancing module on the computing device;
enable the end-user to select an audio track and combine the selected audio track with at least one of: the multimedia content recorded using the camera; the multimedia content selected from the memory of the computing device by the multimedia content enhancing module;
send the audio track and at least one of: the multimedia content recorded using the camera; the multimedia content selected from the memory to the cloud server by the multimedia content enhancing module;
receive and analyze beats characteristics of the audio track and at least one of: the multimedia content recorded; the multimedia content selected from the memory by a multimedia analyzing and visual effects retrieving module on the cloud server;
retrieve and categorize a series of visual effects and filters into multiple types by the multimedia analyzing and visual effects retrieving module based on different beat characteristics in the audio track, and one or more video components of at least one of: the multimedia content recorded; the multimedia content selected from the memory;
deliver the series of categorized visual effects and filters to the computing device from the cloud server over the network;
display categorized visual effects and filters on the multimedia content enhancing module and enable the end-user to select and apply the categorized visual effects and filters to at least one of: the multimedia content recorded; the multimedia content selected from the memory; to create an enhanced multimedia content; and
enable the end-user to share and post the enhanced multimedia content on the computing device by the multimedia content enhancing module.
